(19) United States
(12) Patent Application Publication
(10) Pub. No.: US 2021/0221337 A1
(43) Pub. Date: Jul. 22, 2021

(54) APPARATUS AND METHODS FOR WASHING HEAVY VEHICLES

(71) Applicant: Newterra Limited, Brockville (CA)

(72) Inventors: Robert Kennedy, Brockville (CA); Jeffrey Kempson, Brockville (CA)

(21) Appl. No.: 17/151,845

(22) Filed: Jan. 19, 2021

Related U.S. Application Data
(60) Provisional application No. 62/963,050, filed on Jan. 19, 2020.

(51) Int. Cl. B60S 3/04; B08B 3/02; B08B 15/00

(52) U.S. Cl. CPC B60S 3/04; B08B 2230/01; B08B 15/00; B08B 3/02

(57) ABSTRACT

Vehicle washing apparatus has a platform for supporting a vehicle and a filtering grid covering the platform. A hopper under the grid receives a combination of water after its use in washing the vehicle and waste removed from the vehicle surface by the washing. Larger solid matter is retained on the grid. The fluid combination is pumped from the bottom of the hopper to a clarifier having another hopper. Another pump is used to pump bottom-lying residue from the other hopper into a separator bag formed of mesh material permitting drainage of water from the separator bag into the clarifier while maintaining solids within the separator bag.

### CROSS REFERENCE TO RELATED PATENTS

This application claims priority from U.S. provisional patent application no. 62/963,050, filed Jan. 19, 2020 and entitled “Apparatus and methods for washing heavy vehicles”, the contents of which are incorporated herein by reference.

### FIELD OF THE INVENTION

This invention relates to apparatus and methods for washing heavy vehicles and is especially but not exclusively related to apparatus in modular form allowing for relatively easy transfer between storage and deployment sites and for assembly at the deployment sites.

### SUMMARY OF THE INVENTION

According to one aspect of the invention, there is provided vehicle washing apparatus comprising a platform structure for supporting a vehicle, a filtering grid covering the platform structure, a first hopper mounted under the filtering grid for receiving a fluid combination of water after use thereof in washing the vehicle and waste removed from the vehicle surface by said washing other than matter retained on the filtering grid, a first pump to pump said fluid combination from the bottom of the first hopper to a clarifying unit having a second hopper, a second pump to pump bottom-lying residue from the second hopper into a separator bag formed of mesh material permitting drainage of water from the separator bag while maintaining solids within the separator bag.

According to another aspect of the invention, there is provided, a method of washing a vehicle comprising driving the vehicle onto a supporting platform structure, jet washing the vehicle to dislodge waste material accumulated on the vehicle, screening pieces of the waste material greater than a threshold size using a grid mounted over the platform structure having, and collecting screened waste material containing pieces less than the threshold size in a first hopper located under the grid, pumping the waste material from the bottom of the first hopper to a clarifying unit having a second hopper, pumping bottom-lying residue from the second hopper into a separator bag formed of mesh material permitting drainage of water from the separator bag back into the clarifier while maintaining solids within the separator bag.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a perspective view of vehicle washing apparatus according to one embodiment of the invention.

FIG. 2 is a schematic diagram showing a collection module and a treatment module forming parts of vehicle washing apparatus according to an embodiment of the invention.

FIG. 3 is a perspective view of a clarifier and solids bag arrangement forming part of the apparatus of FIG. 1.

FIG. 4 is a plan view of a clarifying unit forming a part of vehicle washing apparatus according to an embodiment of the invention.

FIG. 5 is a scrap perspective view showing an ejection mechanism for the solids bag arrangement of FIG. 3.

FIG. 6 shows a platform module forming part of the apparatus of FIG. 1

FIG. 6A shows another representation of the platform module of FIG. 6.

FIG. 7 shows a pair of the platform modules of FIG. 6 in stacked relationship for shipping purposes.

FIG. 8 is a perspective view of a corner box arrangement for use in connecting modules of the vehicle washing apparatus of FIG. 1.

FIG. 9 is a perspective view from the front and one side showing an alternative form of ejection mechanism for ejecting the solids bag.

FIG. 10 is a perspective view from the rear and the one side showing the ejection mechanism of FIG. 9.

FIG. 11 is a perspective view of ramps for use with the vehicle washing apparatus of FIG. 1, the ramps being stacked for facilitating transportation thereof.

### DETAILED DESCRIPTION OF THE INVENTION INCLUDING THE PRESENTLY PREFERRED EMBODIMENTS

Heavy vehicles may be any of tanks, excavating and construction vehicles, trucks, buses, and similar vehicles in terms of having heavy weight and generally operating over rough terrain. A typical make of tank for which the present invention finds application has a weight of 70,000 pounds, a length of 32 feet, a width of 12 feet and a height of 8 feet. A typical make of truck for such use has a weight of 20,000 pounds, a length of 19½ feet, and a width and height of 7½ feet.

A heavy vehicle, when being returned from field use, may have up to 1200 pounds of mud, rock, and other debris coating the vehicle surface or lodged in nooks, crannies and re-entrant formations in the vehicle body. At a vehicle washing site, which may be a somewhat temporary facility, it is desirable in order to preserve the local environment, to minimize any polluting effect of the water used to wash the heavy vehicle and of solids removed by such washing. This effectively means keeping all washing liquid and removed solids away from the underlying ground during operation, collecting and removing solids periodically from the site while it is operational, and removing all washing liquids and removed solids when the site is decommissioned.

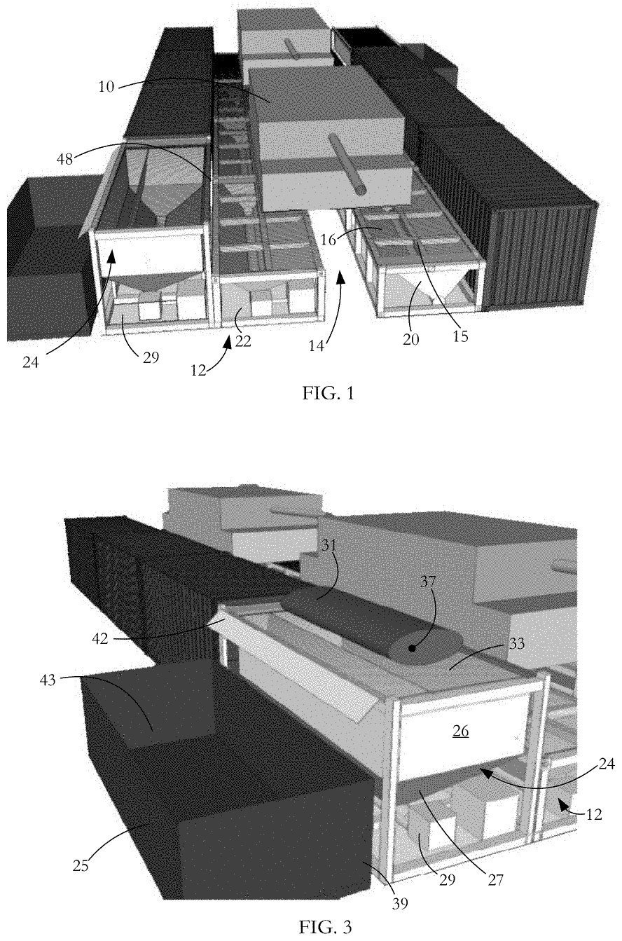

As shown in FIG. 1, a vehicle 10 to be washed, after being brought to the washing site, is driven up approach ramps 11 (FIG. 11) onto laterally spaced platform structures 12 forming part of a collection module 13 as shown in the schematic view of FIG. 2. Positioning a heavy vehicle on the spaced platforms 12 allows access to the vehicle underside from a well 14 between laterally adjacent platforms 12. A heavy duty, stainless or galvanized steel, welded bar grate 15 mounted over the top of each platform provides support for vehicle treads or wheels and has a bearing capacity up to 80 tons (40 tons each side). The grates 15 also provide walkways 48 for wash and clarifier maintenance operators. Each of the spaced platforms 12 has a central, longitudinally positioned beam 16 so that, when supporting a particularly heavy vehicle such as a tank, the tank tracks have additional support from the beam.

In one embodiment of the invention, manual operators standing on the walkways 48 at each side of the vehicle or in the well 14 wash the vehicle with three different types of water cannons/wands as shown in FIG. 2. In a first washing phase, vehicles are washed with high volume cannons 17 having two or more bubble cup nozzles per side to deliver washing water at a total rate of 100 gallons per minute (GPM). In a second phase, vehicles are washed with water delivered from high pressure wands 18 supplied from a cold or hot water pressure wash system at a rate of 5 GPM and a pressure of 3000 psi. In a third phase, vehicles are washed with steam delivered from heavy duty steam washer guns 19 supplied from a hot water and steam generator. Water for cannons, guns and wands is supplied from a water treatment module 50. Other combinations of water flow rate, nozzle pressure, temperature, application times, etc., can be adopted depending on the nature of material to be removed such as dirt, rock, grease, salt, etc. In another exemplary embodiment two wash phases are used. High flow/lower pressure water cannons at 110 psi and up to 40 gallons per minute variable flow are used for removal of mud and dirt. Dual purpose, low flow, high pressure warm water or steam is used for removal of oil/grease and bio-solids.

The stainless steel bar grate 15 acts as a primary screen for rocks and trash which accumulate on the grate in the course of washing. Solids retained on the grate are periodically removed from the grate 15 into a waste bin 43 for remote disposal, the bins 43 located beside respective clarifier units 24.

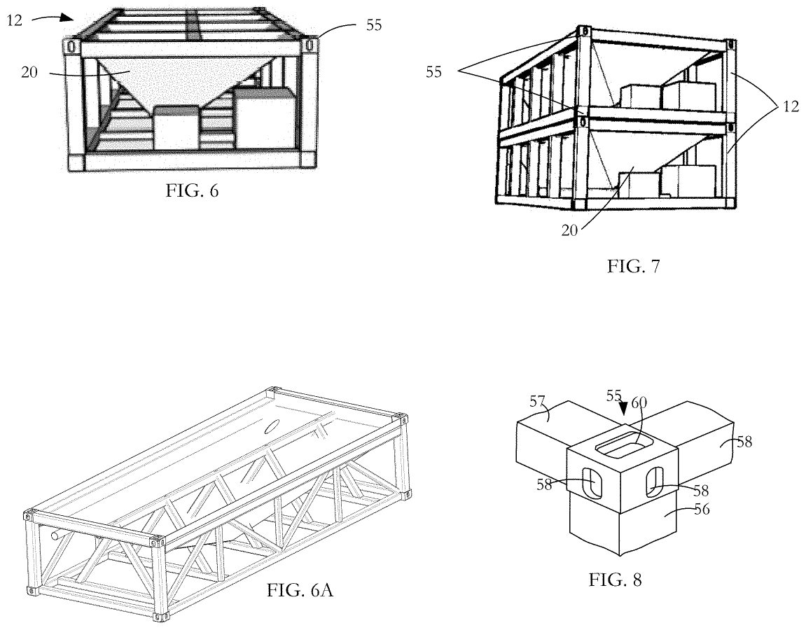

The platforms 12 each have an integral underlying V-bottom mud and debris collection hopper 20. In the embodiment shown in FIG. 1, there are eight such hoppers 20; four in each of the spaced platform ‘spans’ located either side of the central well 14. The hoppers 20 each have a mud/water volume capacity of 234 cubic feet (1700 gallons) with mud weight capacity of 25,000 lb although these upper limits are not reached as long as washing, water treatment and disposal cycles are proceeding normally. As shown in FIG. 2, suction pumps 22 draw mud at a rate of 20 GPM from each collection hopper 12. As shown in FIG. 6A, overflow pipes connecting adjacent hoppers 12 enable bypassing of a broken pump 22 with adjacent pumps 22 then temporarily taking the load from the broken pump. Pumped mud is transferred to primary screens 23 mounted on top of clarifying units 24 shown in FIG. 1, the screens having a preferred mesh size of from 0.5 to 2.0 mm. The screens are mounted in a slant orientation so that screened material rolls and slides down the screens 23 and dumps into respective waste bins 25 while resulting filtrate is pumped into the clarifier 24. An LED lighting array (not shown) with waterproof packaging is mounted in the well 14 for illuminating vehicle undersides.

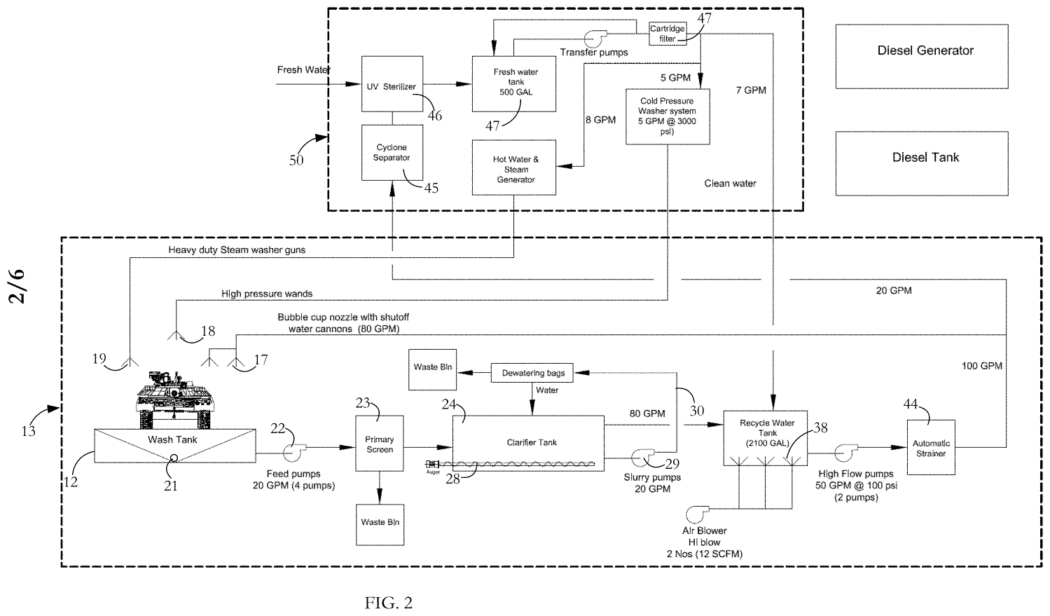

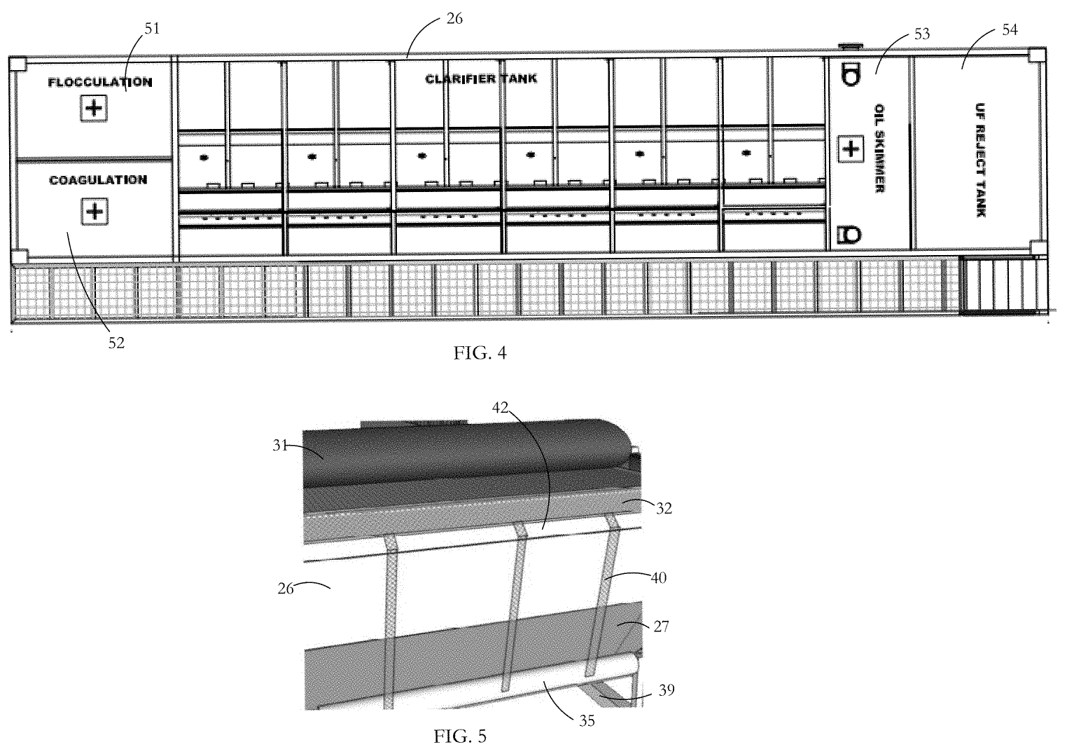

As shown by FIGS. 3 and 4, the clarifying unit 24 has a rectangular tank 26 with a V-section lower hopper 27 and is used to clarify water pumped into it by removing particulate solids. In the clarifier 24, heavy particles settle to the bottom of the V-hopper 27 as sludge for later discharge and light particles float to the surface of the liquid for removal as scum. As shown in FIG. 4, before water to be treated enters the clarifier tank 26, it is subjected to flocculation and coagulation processes in side chambers 51, 52 using, for example, polyelectrolytes and ferric sulfate which cause fine particles to clump together to form flocs that are more stable and are quicker to settle than the fine particles. This enables solids to be separated out more quickly and efficiently in the clarifier tank 26. Accumulated solids are removed mechanically using slow-moving devices to avoid agitation and re-suspension of the settled solids. For the same reason, water inlet and outlet devices are designed to minimize turbulence by using baffles and overflow weirs and by regulating flow rates and directions. Sloping tube or lamellar media are commonly used in the clarifiers to increase settling capacity by reducing the vertical drop that a suspended particle has to travel. The settling media present multiple narrow parallel flow pathways encouraging uniform laminar flow. The media provide a large settling area to encourage stabilization of sediment. Flow speed stalling, which occurs at the ends of the sloping tubes or lamellar plates, encourages further fine particle aggregation.

In use, solids gather through particle interaction and slide down the clarifying media under gravity while clarified water flows out of the top of the media and is piped to a recycle water tank 34 (FIG. 2). An oil skimmer is deployed periodically to skim oil from the surface of the clarifying unit and to drive it into a collection barrel.

As shown by FIGS. 2 and 3, in the clarifier 24, an auger 28 is used intermittently to transport sludge accumulating in the bottom of V-form hopper 27 forming part of the clarifying unit to a 20 GPM slurry pump 29. The sludge is pumped from the bottom end of the hopper 27 via pump 29 and hose 30 into a solids filter bag 31 positioned on top of the clarifier 24. The bag 31 has a mesh aperture size of from 130 to 170 microns, preferably 150 microns, and sits atop platform constructed from steel grating.

In use, water leaks out of the bag 31 and falls through a transport mesh 32 (FIG. 5) and a support grid 33 back into the clarifier 24. In the process, the solids in the bag 31 are dewatered. When the solids bag 31 is full as shown by its expanded shape and size and the emergence of spray from the top of the bag, pumping is stopped. After a short period of further drainage, hose 30 is unclipped from the bag 31 at a quick action cam lock fitting 37. Referring to FIG. 5, to remove a filled bag, motorized rollers 35 are turned about their axes to wind up or unwind respective straps 40 causing the transport mesh 32 to slide laterally across the top of the clarifier 24 to move the filled bag 31 onto a sloping deflector plate 42 where the bag 31 rolls off the plate and falls into disposal bin 43. The transport mesh 32 is then returned to its original position to receive a new bag. When changing bags, the slurry pump 29 is shut off and can remain off for a period of time even as the overall process continues and sludge build up in the bottom of the clarifier 24. In one implementation, the solids bag 31 weighed of the order of 2000 kg when full. Typically, bag exchange took about 10 minutes.

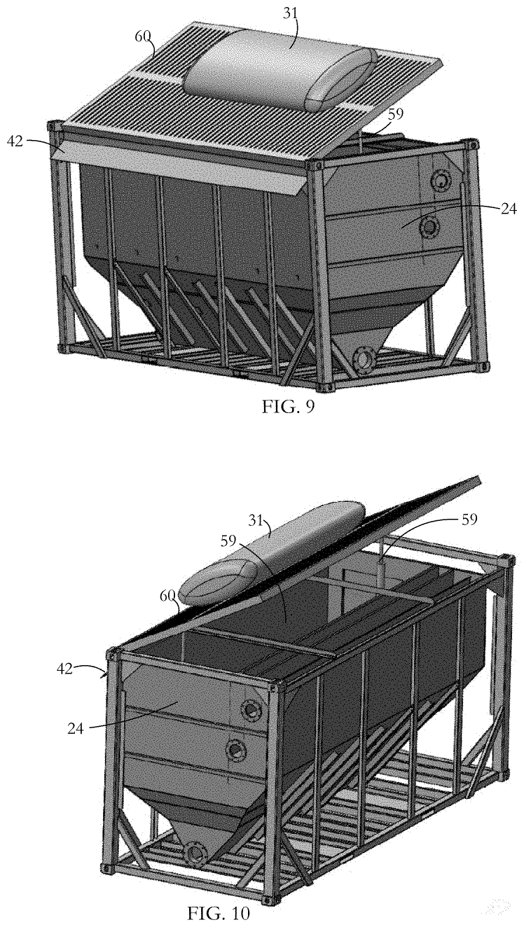

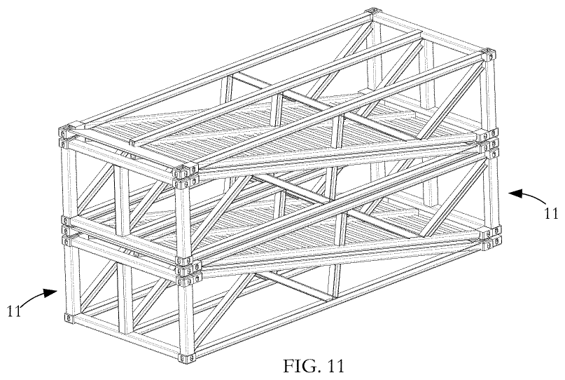

In an alternative embodiment as shown in FIGS. 9 and 10, the solids bag 31 is supported on a grate 60 hingedly mounted on top of the clarifier 24. Two hydraulic jacks 59, mounted on the clarifier, are used to lift one side of the grate 60 to roll the bag 31 off the grate 60 and into the disposal bin 43. A hydraulic motor (not shown) for operating the jacks is mounted underneath the clarifier 24.

At the recycle water tank 34, water from the clarifier 24 is subjected to aeration 38 to keep the contents fully mixed and to prevent settling. Water from the recycle tank 34 is pumped though an automatic strainer 44 to a cyclone separator 45 forming an initial stage in the water treatment module 50. The strainer and cyclone separator are used to further filter and reduce colloidal solids size to less than 50 microns and less than 100 ppm of total suspended solids. The solids are piped back to the clarifier for removal and settling.

Water from the cyclone separator 45 is taken through an ultra-violet sterilizer 46 where it is subjected to a radiation dose of of 40 mJ/cm2 and then piped to a modified ISO container constituting a fresh water tank 47 in preparation for re-use in the washing process. The water in the fresh water tank 47 is cloudy, but free from particulates. Quick connect couplings on the exterior of the fresh water container 47 project through the container roof next to the operator catwalk 48 enabling connection of hoses 49 for supplying the washing devices. When required for washing, water from the fresh water tank 47 is piped into feed hoses to the high volume, the cold high pressure and the steam high pressure washing devices 17, 18, 19 previously described, the piped water being first directed through a cartridge filter to ensure the water has all the suspended solids removed with a 20 micron filter efficiency. At installation start-up, the clarifier 24 and the fresh water tank 47 are filled with water and, to the extent possible, this initially introduced water, suitably treated and supplemented, is all that is used for subsequent vehicle washing at the site.

As can be seen from FIGS. 1, 6 and 7, components of the washing apparatus are modular in design. Each of the modules is designed either to fit inside a standard ISO container or has the volume and height of a standard ISO container so that it can be shipped in the manner and with the ease with which standard ISO containers are shipped. For shipping purposes, for example, as shown in FIG. 7, one of the platforms 12 is mounted on top of another platform 12 of the same length and width, the platforms being so dimensioned that when stacked, they occupy the footprint and height of a standard ISO intermodal container. Similarly, as shown in FIG. 11, ramps 11 used for driving a heavy vehicle onto and off a run of platforms 12 are stacked with alternate inversions.

Both for shipping and for installation at a washing facility, converted container modules and container-size modules are fixed together using corner boxes 55 as illustrated in FIG. 8. The boxes 55 are the carrying fixtures for moving the modules between different transport equipment and are welded to strength members 56, 57, 58 extending between adjacent corners of a module along its height, width and length. Each connector box 55 has an aperture 58 in each side and end and an aperture 60 in each of its top and bottom. The end and side apertures 58 accommodate interconnection devices for connecting adjacent modules together either for shipping or for assembling them together at vehicle the washing facility. The apertures 60 are used for lifting the modules and for vertically anchoring stacked modules together.

A typical intermodal container (also called a shipping container, freight container, ISO container, hi-cube container, box, conex box and sea can) is a standardized reusable steel box used for the storage and movement of materials and products within a global containerized intermodal freight transport system. External lengths of containers, which each have a unique ISO 6346 reporting mark, vary from 8 feet (2.438 m) to 56 feet (17.07 m) with the most common lengths being 20 feet and 40 feet. Heights of containers compliant with ISO 6346 are from 8 feet (2.438 m) to 9 feet 6 inches (2.9 m). Widths are generally 8 feet. For use in the heavy vehicle washing apparatus described, preferred dimensions are 20 feet length, 8 feet wide and either regular (8.5 feet) or high cube (9.5 feet) tall.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. Vehicle washing apparatus comprising a platform structure for supporting a vehicle, a filtering grid covering the platform structure, a first hopper mounted under the filtering grid for receiving a fluid combination of water after use thereof in washing the vehicle and waste removed from the vehicle surface by said washing other than matter retained on the filtering grid, a first pump to pump said fluid combination from the bottom of the first hopper to a clarifying unit having a second hopper, a second pump to pump bottom-lying residue from the second hopper into a separator bag formed of mesh material permitting drainage of water from the separator bag while maintaining solids within the separator bag.

2. Vehicle washing apparatus as claimed in claim 1, wherein the bag is positioned over the clarifying unit whereby the water from the separator bag drains into the clarifying unit.

3. Vehicle washing apparatus as claimed in claim 2, further comprising a drainage grid mounted on the clarifying unit to support the separator bag, the grid allowing said drainage of water into the clarifying unit.

4. Vehicle washing apparatus as claimed in claim 3, further comprising an ejection sub-system for ejecting the separator bag, when filled, from its position over the clarifying unit.

5. Vehicle washing apparatus as claimed in claim 4, wherein the ejection sub-system includes a reciprocal mat intermediate the separator bag and the drainage grid.

6. Vehicle washing apparatus as claimed in claim 4, wherein the ejection sub-system comprises the drainage grid being hingedly mounted on the clarifying unit and at least one hydraulic jack to raise a part of the grid to roll the separator bag from the drainage grid.

7. Vehicle washing apparatus as claimed in claim 4, further comprising a disposal bin adjacent the clarifying unit to receive the ejected separator bag.

8. Vehicle washing apparatus as claimed in claim 4, wherein the ejection sub-system further comprises a deflector bar intermediate the clarifying unit and the bin to deflect the separator bag as it is ejected from its position over the clarifying unit.

9. Vehicle washing apparatus as claimed in claim 1, wherein the separator bag is formed of a material having a mesh aperture size in the range 100 to 200 microns across.

10. Vehicle washing apparatus as claimed in claim 1, further comprising a first conveyor in the first hopper to convey material in the bottom of the first hopper towards the first pump.

11. Vehicle washing apparatus as claimed in claim 1, further comprising a second conveyor in the second hopper to convey material in the bottom of the second hopper towards the second pump.

12. Vehicle washing apparatus as claimed in claim 1, the apparatus having two such platform structures laterally spaced from each other for supporting a vehicle with two laterally spaced wheel lines/tracks on respective ones of the platform structures.

13. Vehicle washing apparatus as claimed in claim 12, the two platform structures sufficiently broad to provide catwalks on the filtering grid either side of a central vehicle supporting region.

14. Vehicle washing apparatus as claimed in claim 12, further comprising a lighting sub-system mounted between the spaced platform structures for illuminating a vehicle underside.

15. Vehicle washing apparatus as claimed in claim 1, further comprising a water tank for the supply of water to washing devices, the water tank supplied with clarified water from the clarifying unit.

16. Vehicle washing apparatus as claimed in claim 1, further comprising the apparatus being of modular form, each module dimensioned to fit into a container having length, height and width dimensions of an ISO standard intermodal container.

17. Vehicle washing apparatus as claimed in claim 15, wherein the washing devices are at least one of a high volume cannon, a high pressure cold water wand and a high pressure hot water/steam wand.

18. Vehicle washing apparatus as claimed in claim 1, wherein at least one of the hoppers has at least one wall sloping inwardly and downwardly.

19. A method of washing a vehicle comprising driving the vehicle onto a supporting platform structure, jet washing the vehicle to dislodge waste material accumulated on the vehicle, screening pieces of the waste material greater than a threshold size using a grid mounted over the platform structure having, and collecting screened waste material containing pieces less than the threshold size in a first hopper located under the grid, pumping the waste material from the bottom of the first hopper to a clarifying unit having a second hopper, pumping bottom-lying residue from the second hopper into a separator bag formed of mesh material permitting drainage of water from the separator bag back into the clarifier while maintaining solids within the separator bag.

20. The method as claimed in claim 19, further comprising using clarified water from the clarifying unit as a source of water for the jet washing.
